(19) United States
(12) Patent Application Publication
(10) Pub. No.: US 2025/0339718 A1
(43) Pub. Date: Nov. 6, 2025

(54) FIRE SUPPRESSION PROCESS

(71) Applicant: Fireguardia, Inc., Midland, NC (US)

(72) Inventors: Oscar A. Dominguez, Quetzaltenango (GT); Heather Towsley, San Marcos, CA (US)

(21) Appl. No.: 19/192,752

(22) Filed: Apr. 29, 2025

Related U.S. Application Data
(60) Provisional application No. 63/641,160, filed on May 1, 2024.

(51) Int. Cl. A62C 37/36; A62C 99/00

(52) U.S. Cl. CPC A62C 37/36; A62C 99/0027; A62C 99/0045

(57) ABSTRACT

The subject matter of the present invention includes a fully automatic, early detection fire suppression method. The fire suppression method implements MEMS technology combined with artificial intelligence (AI) and machine learning (ML). The fire suppression method includes real-time monitoring, fire detection sensors, and diagnostics algorithms. A uniquely integrated application of technologies provides for distinguishing between safe and dangerously destructive fire events and the instantaneous extinguishing of a dangerous fire at its inception.

### CROSS-REFERENCE TO RELATED APPLICATIONS

This application claims benefit of priority with U.S. Provisional Application Ser. No. 63/641,160, filed May 1, 2024; the entire contents of which are hereby incorporated by reference.

### BACKGROUND

### Field of the Invention

The present invention comprises a fully automatic early detection fire suppression method for consumer and industrial applications. The fire suppression method integrates the use of a proprietary non-toxic, fire suppression powdery vegetal biomass composition, as disclosed in U.S. Pat. No. 12,071,581, herein incorporated by reference.

### Description of the Related Art

Home structure fires are responsible for the largest number of related deaths in the world. In the United States alone, thousands of lives are lost annually, with property losses exceeding $147 billion. The present-day fire suppression systems within the fire protection industry have proven to be extremely inadequate and ineffective in addressing the numerous deficiencies that exist, inclusive of early detection, rapid response, the effect on the environment, and, most importantly, life and public health.

Depending on the specific source of the fire, whether it be wood, paper, fabric, or plastic, or the cause of the fire, whether it be flammable liquids, grease, or electrical equipment, as examples, many different types of equipment and retardants are necessary to selectively extinguish those classifications of fire. In the case of using the present-day retardants available, they are filled with carcinogens, mutagens, and toxic chemicals, resulting in millions of deaths. Furthermore, while water in many cases is used to extinguish fires, in the case of a grease fire water cannot be used because it creates a more dangerous situation.

### SUMMARY

The subject matter of the present invention comprises a fully integrated automatic and continuous monitoring, early detection, fire-identifying, alarm, and suppression system that senses, detects, and immediately suppresses the flames of a dangerous fire. The fire suppression system utilizes a proprietary, non-toxic fire suppression powdery composition unique to the process, prioritizing safety, health, wellness, and environmental preservation.

The fire suppression method implements a unique utilization of software, analyzing infrared sensor signatures, providing effective and efficient continuous monitoring, which results in early detection and determination of a dangerous fire, emits an alert, and triggers the immediate suppression response while simultaneously issuing notifications to a proprietary mobile app. Accordingly, serious and deadly fires are prevented, eliminating extensive loss of life and property. The fire suppression invention implements MEMS technology, integrated with artificial intelligence and machine learning (AI/ML).

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments that will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein. Unless explicitly defined herein, terms are to be construed in accordance with the plain and ordinary meaning as would be appreciated by one having skill in the art.

Unless explicitly defined herein, terms are to be construed in accordance with the plain and ordinary meaning as would be appreciated by one having skill in the art.

### General Description of Embodiments

The subject matter of the instant invention relates to a fully integrated automatic, early detection, fire suppression method that identifies and immediately extinguishes the flames of a dangerous fire. The computerized fire suppression method continuously monitors in real time.

The early detection fire suppression method comprises an array of computerized autonomous fire detection sensors uniquely synchronized with diagnostic algorithms configured and programmed to detect the presence of fire, analyze the threat level, and, if dangerous, instantaneously extinguish the flames.

The fully integrated fire suppression method comprises an array of infrared sensors that continuously monitor heat level, ambient temperature, color, flame size, flickering, and intensity, along with a carbon monoxide sensor and a barometric pressure sensor.

The array of autonomous infrared fire detection sensors is uniquely synchronized with the diagnostic algorithms of a microcontroller unit (MCU) configured and programmed to process sensor data and determine fire presence. The MCU receives information from the sensors that are programmed with software to continuously monitor and detect for the presence of fire. If a fire event is identified, the sensors analyze the fire to determine if it is a threat. The sensors continuously report the proximity of the MCU and the sensors to the fire. If determined to be dangerous, the fire is immediately extinguished at its inception by blanketing the flames with a non-toxic, flameproof powder.

The carbon monoxide sensors continuously check the air quality for the presence of smoke and carbon monoxide. The infrared sensors check for the presence of fire, any sudden change in ambient temperature, and the intensity of the fire, including flickering, flame size, color, and growth rate. Diagnostics routinely check the interaction between the sensors and the MCU as to functionality to ensure that all aspects of the process are operating correctly.

Once one of the sensors detects any sudden flame burst accompanied by a heat wave and rapid increase in temperature, programmed software will run emergency protocols. The sensors continue to monitor all of the critical data point parameters every microsecond.

If a dangerous fire is identified, the MCU cross-verifies the detection using data specifically from the infrared sensors. The sensors continue to measure the intensity, flickering, temperature, growth rate, and color of the flames. Software codes analyze the infrared signatures, differentiating between a safe and a hazardous fire event.

If a dangerous fire is confirmed, the MCU instantaneously triggers pressurized carbon dioxide, activating the immediate discharge of a non-toxic, flameproof vegetal biomass in powdery form that suppresses the flames. The use of the proprietary all-natural fireproof composition as referred to herein above is a differentiator for the safe implementation of the defined methodology, safely addressing all classifications of the fire causation as stated above.

Programmed software provides for automatic suppression redundancy, if necessary.

The fire suppression method of the present invention will normally be fully integrated in a self-contained housing for both industrial and consumer use. The size of the housing and design will vary depending on the specific application.

It will be apparent to those skilled in the art that various modifications and variations can be made in the present invention without departing from the spirit and scope of the invention. Thus, it is intended that the present invention covers any modifications and variations of the invention, provided they come within the scope of the appended claims and their equivalents.

What is claimed is:

1. A fully automatic fire suppression method comprising an array of computerized, autonomous, fire detection sensors uniquely synchronized with diagnostic algorithms configured and programmed to detect the presence of fire, analyze the threat level, and, if dangerous, instantaneously extinguish the flames.

2. The fire suppression method of claim 1, wherein said array of sensors comprises infrared sensors that continuously monitor heat level, ambient temperature, color, flame size, flickering, and intensity, along with a carbon monoxide sensor and a barometric pressure sensor.

3. The fire suppression method of claim 2, whereupon the identification of a fire event, said algorithms cross-verify the detection with data from the infrared sensors to determine the critical nature of the fire.

4. The fire suppression method of claim 1, wherein the flames of a dangerous fire are extinguished by a non-toxic, fireproof powder.

5. The fire suppression method of claim 4, wherein said fireproof powder is composed of all-natural ingredients.

6. The fire suppression method of claim 5, wherein said fireproof powder comprises amylopectin, amylose, collagen-keratin-elastin, and sodium bicarbonate.

7. The fire suppression method of claim 4, whereupon the identification of a dangerous fire, pressurized carbon dioxide blankets the flames with said fireproof powder.

8. The fire suppression method of claim 2, wherein said integrated, autonomous sensors and programmed algorithms continuously process all of the critical data point parameters of an identified fire every microsecond.

9. The fire suppression method of claim 4, inclusive of programmed software. provides suppression redundancy.
